(19) United States
(12) Patent Application Publication
(10) Pub. No.: US 2017/0003421 A1
(43) Pub. Date: Jan. 5, 2017

(54) Methods of Fabricating Photoactive Substrates for Micro-lenses and Arrays

(71) Applicant: 3D GLASS SOLUTIONS, INC, Albuquerque, NM (US)

(72) Inventors: Jeb H. Flemming, Albuquerque, NM (US); Jeff Bullington, Orlando, FL (US)

(21) Appl. No.: 15/113,748

(22) PCT Filed: Jan. 23, 2015
(86) PCT No.: PCT/US2015/012758

§ 371 Date: Jul. 22, 2016

Related U.S. Application Data
(60) Provisional application No. 61/931,039, filed on Jan. 24, 2014.

(51) Int. Cl. G02B 3/00; C03C 10/00; C03C 4/04

(52) U.S. Cl. CPC G02B 3/0012; C03C 4/04; C03C 10/0009

(57) ABSTRACT

A method of fabrication and device made by preparing a photosensitive glass substrate comprising at least silica, lithium oxide, aluminum oxide, and cerium oxide, masking a design layout comprising form one or more micro lens on the photosensitive glass substrate, exposing at least one portion of the photosensitive glass substrate to an activating energy source, exposing the photosensitive glass substrate to a heating phase of at least ten minutes above its glass transition temperature, cooling the photo sensitive glass substrate to transform at least part of the exposed glass to a crystalline material to form a glass-crystalline substrate and etching the glass-crystalline substrate with an etchant solution to form one or more a micro lens.

### TECHNICAL FIELD OF THE INVENTION

The present invention relates to a method to fabricate a glass structure and, in particular, a method to fabricate micro-lenses and micro-lens arrays in glass ceramic substrates for focusing, collimating and imaging in general.

### BACKGROUND ART

Photosensitive glass structures have been suggested for a number of micromachining and microfabrication processes such as integrated imaging elements in conjunction with other elements systems or subsystems, micro-lens, micro-lens arrays. Silicon microfabrication of traditional glass is expensive and low yield while injection modeling or embossing processes produce inconsistent optical shapes and micro lenses. Silicon microfabrication processes rely on expensive capital equipment; photolithography and reactive ion etching tools that generally cost in excess of one million dollars each and require an ultra-clean, high-production silicon fabrication facility costing millions to billions more. Injection molding and embossing are less costly methods of producing a micro-lens but generate defects with in the transfer or have differences due to the stochastic curing process.

This invention provides creates a cost effective glass ceramic micro-lens and/or micro-lens array device. Where glass ceramic substrate has demonstrated capability to form such structures through the processing of both the vertical as well as horizontal planes either separately or at the same time to form three dimensional micro-lens or micro-lens array devices.

### DISCLOSURE OF THE INVENTION

The present invention includes a method to fabricate a substrate with one or more optical micro-lens by preparing a photosensitive glass substrate and further coating with one or more metals.

A method of fabrication and device made by preparing a photosensitive glass ceramic composite substrate comprising at least silica, lithium oxide, aluminum oxide, and cerium oxide, masking a design layout comprising one or more micro-lens on the photosensitive glass substrate, exposing at least one portion of the photosensitive glass substrate to an activating energy source, exposing the photosensitive glass substrate to a heating phase of at least ten minutes above its glass transition temperature, cooling the photosensitive glass substrate to transform at least part of the exposed glass to a crystalline material to form a glass-crystalline substrate and etching the glass-crystalline substrate with an etchant solution to form one or more angled channels that are then coated.

### DESCRIPTION OF THE DRAWINGS

Further benefits and advantages of the present invention will become more apparent from the following description of various embodiments that are given by way of example with reference to the accompanying drawings:

FIG. 1 is an image of the process of making the glass ceramic composition of the present invention.

FIG. 2 are images of micro-lens or micro-lens array.

FIGS. 3A and 3B are images of the angled etched features of the present invention the angles can be at any angle from 0-45 degrees.

FIGS. 4A-4D are images of the spatially resolved optical elements and accompanying graphs.

FIG. 5 is an image of one embodiment of the present invention including an angled channel with a reflective coating such that the light may pass and be reflected in a different angle.

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not restrict the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

To address these needs, the present inventors developed a glass ceramic (APEX® Glass ceramic) as a novel packaging and substrate material for semiconductors, RF electronics, microwave electronics, and optical imaging. APEX® Glass ceramic is processed using first generation semiconductor equipment in a simple three step process and the final material can be fashioned into either glass, ceramic, or contain regions of both glass and ceramic. The APEX® Glass ceramic possesses several benefits over current materials, including: easily fabricated high density vias, demonstrated microfluidic capability, micro-lens or micro-lens array, high Young's modulus for stiffer packages, halogen free manufacturing, and economical manufacturing. Photo-etchable glasses have several advantages for the fabrication of a wide variety of microsystems components. Microstructures have been produced relatively inexpensively with these glasses using conventional semiconductor processing equipment. In general, glasses have high temperature stability, good mechanical a n d electrically properties, and have better chemical resistance than plastics and many metals. To our knowledge, the only commercially available photoetchable glass is FOTURAN®, made by Schott Corporation and imported into the U.S. only by Invenios Inc. FOTURAN® comprises a lithium-aluminum-silicate glass containing traces of silver ions. When exposed to UV-light within the absorption band of cerium oxide the cerium oxide acts as sensitizers, absorbing a photon and losing an electron that reduces neighboring silver oxide to form silver atoms, e.g.,
Ce³⁺+Ag⁺=Ce⁴⁺+Ag⁰

The silver atoms coalesce into silver nanoclusters during the baking process and induce nucleation sites for crystallization of the surrounding glass. If exposed to UV light through a mask, only the exposed regions of the glass will crystallize during subsequent heat treatment.

This heat treatment must be performed at a temperature near the glass transformation temperature (e.g., greater than 465° C. in air for FOTURAN®). The crystalline phase is more soluble in etchants, such as hydrofluoric acid (HF), than the unexposed vitreous, amorphous regions. In particular, the crystalline regions of FOTURAN® are etched about 20 times faster than the amorphous regions in 10% HF, enabling microstructures with wall slopes ratios of about 20:1 when the exposed regions are removed. See T. R. Dietrich et al., “Fabrication technologies for microsystems utilizing photoetchable glass,” Microelectronic Engineering 30, 497 (1996).

Preferably, the shaped glass structure contains at least one of a micro-optic lens, a micro-optic element. The micro-optic lens is formed in one of three manners. First the micro-optic lens can be fabricated by making a series of concentric circles to form a Fresnel lens. The index of refraction mismatch between the etched regions and the unetched region of the concentric circles create a diffractive optical element or Fresnel lens. Secondly a Fresnel lens can be created by using a series of ring of a material that is deposited on the service of the APEX® glass. As long as the concentric circles of the Fresnel have an index of refraction difference or a thickness difference the Fresnel will apply the optical function to the incident electromagnetic radiation. The third approach is to etch a curved pattern or a step approximation of curved pattern. The curved or step approximation of curved pattern creates a lens where the power of the lens is given by the slope of the curvature and the specific optical function given by the overall shape of the structure.

FOTURAN® is described in information supplied by Invenios (the sole source U.S. supplier for FOTURAN®) is composed of silicon oxide (SiO₂) of 75-85% by weight, lithium oxide (Li₂O) of 7-11% by weight, aluminum oxide (Al₂O₃) of 3-6% by weight, sodium oxide (Na₂O) of 1-2% by weight, 0.2-0.5% by weight antimonium trioxide (Sb₂O₃) or arsenic oxide (As₂O₃), silver oxide (Ag₂O) of 0.05-0.15% by weight, and cerium oxide (CeO₂) of 0.01-0.04% by weight. As used herein the terms “APEX® Glass ceramic”, “APEX glass” or simply “APEX” is used to denote one embodiment of the glass ceramic composition of the present invention.

The present invention provides a single material approach for the fabrication of optical microstructures with photodefinable/photopatternable A APEX glass for use in imaging applications by the shaped APEX glass structures that are used for lenses and includes through-layer or in-layer designs.

Generally, glass ceramics materials have had limited success in microstructure formation plagued by performance, uniformity, usability by others and availability issues. Past glass-ceramic materials have yield etch aspect-ratio of approximately 15:1 in contrast APEX glass has an average etch aspect ratio greater than 50:1. This allows users to create smaller and deeper features. Additionally, our manufacturing process enables product yields of greater than 90% (legacy glass yields are closer to 50%). Lastly, in legacy glass ceramics, approximately only 30% of the glass is converted into the ceramic state, whereas with APEX® Glass ceramic this conversion is closer to 70%.

APEX composition provides three main mechanisms for its enhanced performance: (1) The higher amount of silver leads to the formation of smaller ceramic crystals which are etched faster at the grain boundaries, (2) the decrease in silica content (the main constituent etched by the HF acid) decreases the undesired etching of unexposed material, and (3) the higher total weight percent of the alkali metals and boron oxide produces a much more homogeneous glass during manufacturing.

The present invention includes a method for fabricating a glass ceramic structure for use in forming angled structures, mirrors and glass ceramic materials used in electromagnetic transmission and filtering applications. The present invention includes an angled structure created in the multiple planes of a glass-ceramic substrate, such process employing the (a) exposure to excitation energy such that the exposure occurs at various angles by either altering the orientation of the substrate or of the energy source, (b) a bake step and (c) an etch step. Angle sizes can be either acute or obtuse. The curved and digital structures are difficult, if not infeasible to create in most glass, ceramic or silicon substrates. The present invention has created the capability to create such structures in both the vertical as well as horizontal plane for glass-ceramic substrates. The present invention includes a method for fabricating a glass ceramic micro lens structures for use in imaging. The lens structure can be coated with various metals or oxides, thin films or other materials to modify the index of refraction (e.g., mirrors) or transparent materials to create a lens. In optics the refractive index (or index of refraction) of a substance (optical medium) is a number that describes how light, or any other radiation, propagates through that medium.

The present invention allows for the development of negative refractive index structures, which can occur if permittivity and permeability have simultaneous negative values.

The resulting negative refraction offers the possibility of creating lenses and other exotic optical structures.

Ceramicization of the glass is accomplished by exposing the entire glass substrate to approximately 20 J/cm² of 310 nm light. When trying to create glass spaces within the ceramic, users expose all of the material, except where the glass is to remain glass. In one embodiment, the present invention provides a quartz/chrome mask containing a variety of concentric circles with different diameters.

The present invention includes a method for fabricating a glass ceramic structure for use in forming imaging structures, mirrors and micro lens, micro lens array in glass ceramic materials used in electromagnetic transmission and reflecting applications. The glass ceramic substrate may be a photosensitive glass substrate having a wide number of compositional variations including but not limited to: 60-76 weight % silica; at least 3 weight % K₂O with 6 weight %-16 weight % of a combination of K₂O and Na₂O; 0.003-1 weight % of at least one oxide selected from the group consisting of Ag₂O and Au₂O; 0.003-2 weight % Cu₂O; 0.75 weight %-7 weight % B₂O₃, and 6-7 weight % Al₂O₃; with the combination of B₂O₃; and Al₂O₃ not exceeding 13 weight %; 8-15 weight % Li₂O; and 0.001-0.1 weight % CeO₂. This and other varied compositions are generally referred to as the APEX glass.

The exposed portion may be transformed into a crystalline material by heating the glass substrate to a temperature near the glass transformation temperature. When etching the glass substrate in an etchant such as hydrofluoric acid, the anisotropic-etch ratio of the exposed portion to the unexposed portion is at least 30:1 when the glass is exposed to a broad spectrum mid-ultraviolet (about 308-312 nm) flood lamp to provide a shaped glass structure that have an aspect ratio of at least 30:1, and to provide a lens shaped glass structure. The mask for the exposure can be of a halftone mask that provides a continuous grey scale to the exposure to form a curved structure for the micro lens. A digital mask used with the flood exposure can be used to produce a diffractive optical element or Fresnel lens. The exposed glass is then baked typically in a two-step process. Temperature range heated between of 420° C.-520° C. for between 10 minutes to 2 hours, for the coalescing of silver ions into silver nanoparticles and temperature range heated between 520° C.-620° C. for between 10 minutes and 2 hours allowing the lithium oxide to form around the silver nanoparticles. The glass plate is then etched. The glass substrate is etched in an etchant, of HF solution, typically 5% to 10% by volume, wherein the etch ratio of exposed portion to that of the unexposed portion is at least 30:1 when exposed with a broad spectrum mid-ultraviolet flood light, and greater than 30:1 when exposed with a laser, to provide a shaped glass structure with an anisotropic-etch ratio of at least 30:1.

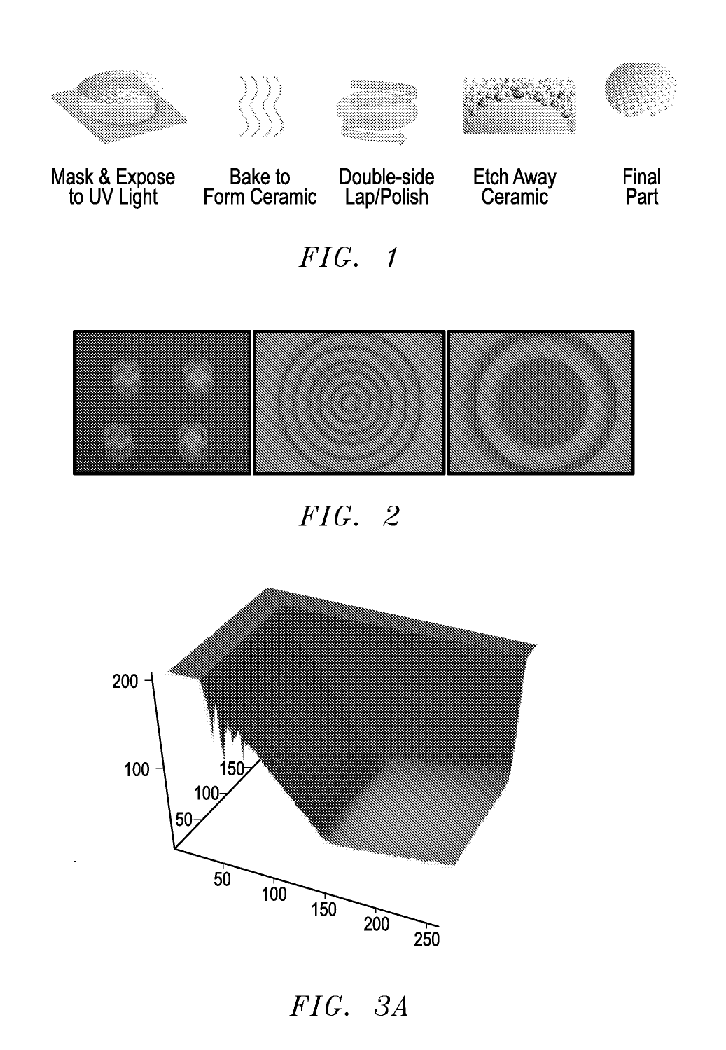

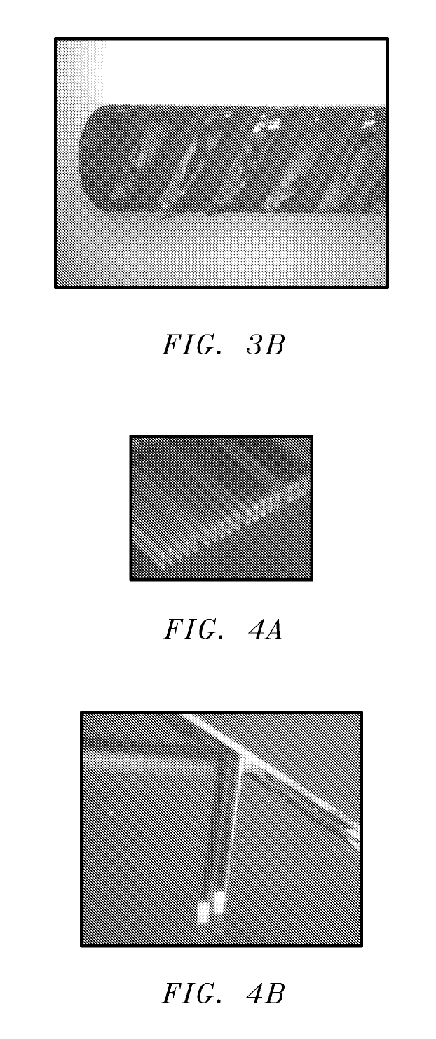

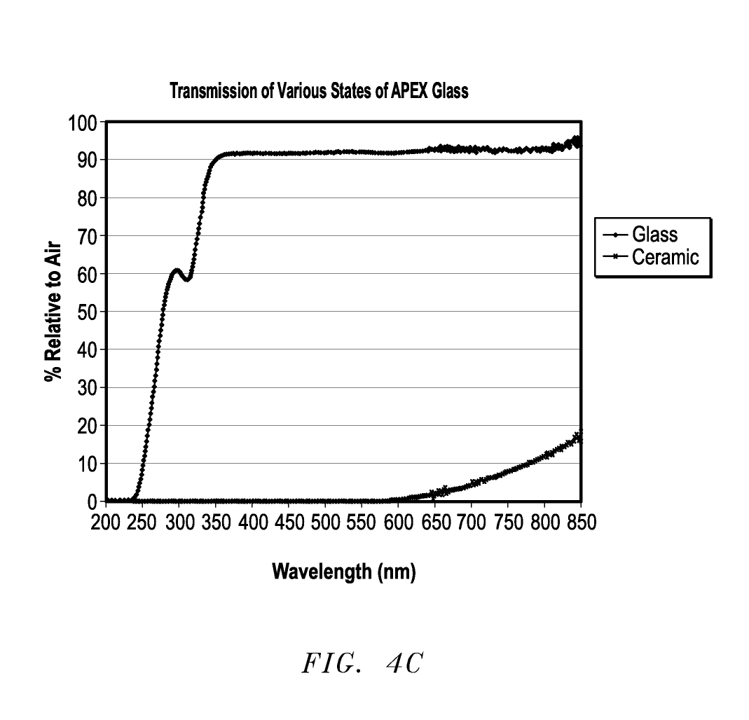

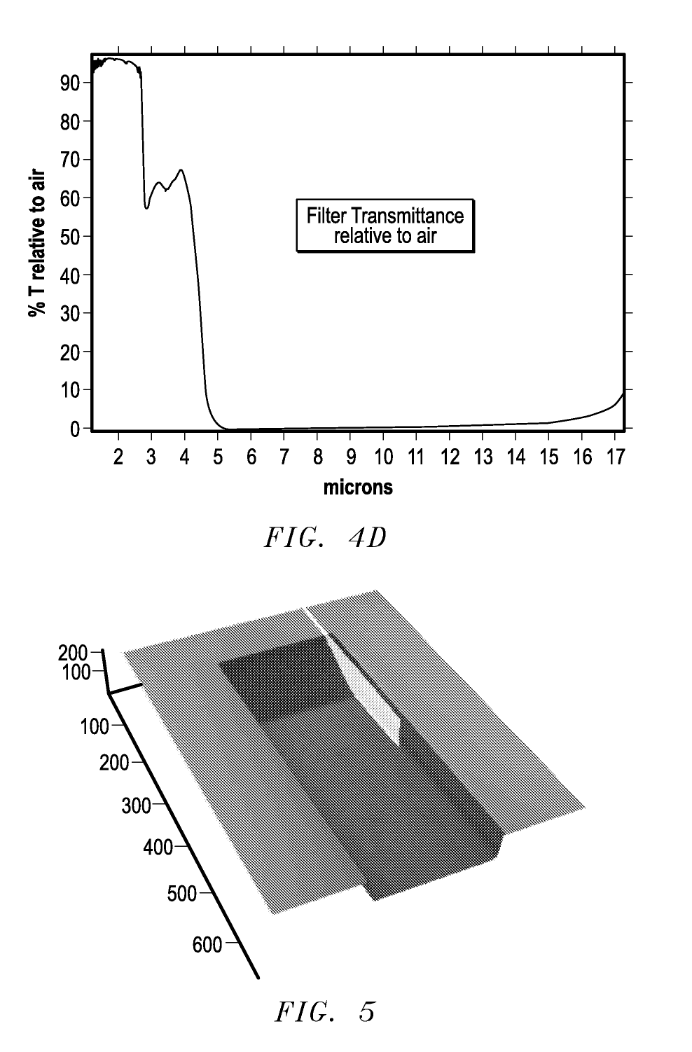

FIG. 1 is an image of the process of making the glass ceramic composition of the present invention. FIG. 2 are images of micro-lens or micro-lens array. FIGS. 3A and 3B are images of the angled etched features of the present invention the angles can be at any angle from 0-45 degrees. FIGS. 4A-4D are images of the spatially resolved optical elements and accompanying graphs. FIG. 5 is an image of one embodiment of the present invention including an angled channel with a reflective coating such that the light may pass and be reflected in a different angle. Not shown is an image of a quartz/chrome mask containing a variety of arcs with different angles and lengths. Not shown is an image of reflection of light by angling it against a copper plated via to reflect light down an alternative path in the adjacent glass.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

1. A method to fabricate an optical comprising the steps of:
a. preparing a photosensitive glass substrate comprising at least silica, lithium oxide, aluminum oxide, and cerium oxide;
b. masking a halftone design with variation in optical density to delineate an optical element in the glass;
c. exposing the photosensitive glass substrate to an activating energy source;
d. exposing the photosensitive glass substrate to a heating phase of at least ten minutes above its glass transition temperature;
e. cooling the photosensitive glass substrate to transform at least part of the exposed glass to a crystalline material to form a glass-crystalline substrate; and
f. etching the glass-crystalline substrate with an etchant solution to form the one or more micro lens device.

2. A method to fabricate an optical element comprising the steps of:
a. preparing a photosensitive glass substrate comprising at least silica, lithium oxide, aluminum oxide, and cerium oxide;
b. masking a digital mask consist transparent non transparent elements to define an diffractive optical element in the glass;
c. exposing at least one portion of the photosensitive glass substrate to an activating energy source;
d. exposing the photosensitive glass substrate to a heating phase of at least ten minutes above its glass transition temperature;
e. cooling the photosensitive glass substrate to transform at least part of the exposed glass to a crystalline material to form a glass-crystalline substrate; and
f. etching the glass-crystalline substrate with an etchant solution to form the one or more micro lens device.

3. The method of claim 1, wherein the optical element is circular with a high optical density on the perimeter and low optical density in the center creating a micro lens.

4. The method of claim 1, wherein gradient of the pattern in the mask provides the optical power of the optical element.

5. The method of claim 2, wherein the optical element is a pattern of high optical density with concentric circles to create a diffractive optical micro lens.

6. The method of claim 5, wherein gradient of the pattern concentric circular circles in the mask provides the optical power of the optical element 5%.

7. The method of claim 1, wherein the halftone design is circular and comprises a high optical density region on a perimeter of the halftone design and a low optical density region in a center region of the halftone design to form a micro lens.

8. The method of claim 1, wherein the halftone design provides an optical power for the micro lens.

9. The method of claim 2, wherein the digital mask comprises a pattern comprising a high optical density region with concentric circles to create a diffractive optical micro lens.

10. The method of claim 2, wherein gradient the digital mask comprises a pattern of concentric circular circles to provide an optical power.
